(19) United States
(12) Patent Application Publication
(10) Pub. No.: US 2007/0068254 A1
(43) Pub. Date: Mar. 29, 2007

(54) DEVICE FOR MEASURING AN AMOUNT OF RINSING ADDITIVES TO BE METERED IN

(75) Inventors: Marco Anstett, Bielefeld (DE); Reimund Pichler, Oelde (DE)

Correspondence Address: DARBY & DARBY P.C., P. O. BOX 5257, NEW YORK, NY, 10150-5257, US

(73) Assignee: Miele & Cie. KG, Guetersloh (DE)

(21) Appl. No.: 11/537,146

(22) Filed: Sep. 29, 2006

(30) Foreign Application Priority Data
Sep. 29, 2005 (DE) 10 2005 046 858.6

(51) Int. Cl. G01H 17/00

(52) U.S. Cl. 73/570; 73/149

(57) ABSTRACT

A measuring device for measuring an amount of a rinsing additive to be metered into a rinsing, washing or disinfecting process in a rinsing machine includes a measuring segment for conveying the rinsing additive. The measuring segment has a defined length and a defined diameter, and includes a first cylindrical widening at an upstream end therof. An ultrasound sensor is associated with the measuring segment for performing a measurement of at least one of a running time, an amplitude and a phase as a function of a flow rate of the rinsing additive so as to enable a determination of at least one of a type and an amount of the additive flowing through the measuring segment. A cap including a cylindrical indentation is received in the cylindrical widening so as to form an annular chamber.

Priority is claimed to German patent application DE 10 2005 046 858.6, filed Sep. 29, 2005, which is hereby incorporated by reference herein.

The present invention relates in general devices for measuring an amount of rinsing additives to be metered into a rinsing, washing or disinfecting process in a rinsing machine. In particular, the present invention relates to a device for measuring an amount of rinsing additives to be metered in wherein the medium to be metered is conveyed through a measuring segment having a defined length and a defined diameter and wherein at least one ultrasound transmitter and at least one ultrasound receiver are employed to carry out a measurement of the running time, the amplitude and/or the phase as a function of the flow rate of the medium, as a result of which the type of medium itself and/or the amount of it flowing through are determined.

### BACKGROUND

A measuring device in which a measurement of the running time, amplitude and/or phase is carried out as a function of the flow rate of the medium by means of at least one ultrasound transmitter and at least one ultrasound receiver is known from “Strömungs-und Durchflussmesstechnik” [Flow and throughput measuring technology] by O. Fiedler, published by R. Oldenburg Verlag, Munich, Vienna, 1992, pp. 230-284, especially FIGS. 6.38, 6.39 and 6.42. With the measuring devices described in this publication, cross flows can occur in the medium that falsify the measured result. Especially in FIG. 6.40, this publication indicates a compensation method in which two measuring segments positioned perpendicularly to each other perform a crosswise measurement. A second pair of sensors is needed for this purpose.

Measuring devices of the above-mentioned type are known from German patent specification DE 29 24 561 C2, German patent application DE 101 56 854 A1, German utility model DE 296 21 964 U1 and European patent application EP 0 479 434 A1. With these measuring devices, a ring-shaped chamber configured as a circular or elliptical hollow cylinder or as a torus is arranged upstream from the measuring segment. The arrangements shown have the drawback that the measuring segment projects into the ring-shaped chamber. As a result, trailing edges are formed that cause eddies in the area of the measuring segment, thus giving rise to measuring errors.

### SUMMARY

Therefore, an object of the present invention is to reduce or prevent cross flows and eddies of the medium in a simple and inexpensive manner in a measuring device of the above-mentioned type.

In and embodiment, the present invention provides a measuring device for measuring an amount of a rinsing additive to be metered into a rinsing, washing or disinfecting process in a rinsing machine. The measuring device includes: a measuring segment configured to convey the rinsing additive, the measuring segment having a defined length and a defined diameter, the measuring segment including a first cylindrical widening at an upstream end therof; at least one ultrasound sensor associated with the measuring segment and configured to perform a measurement of at least one of a running time, an amplitude and a phase as a function of a flow rate of the rinsing additive so as to enable a determination of at least one of a type and an amount of the additive flowing through the measuring segment; and a first cap including a first cylindrical indentation received in the cylindrical widening so as to form a first annular chamber.

Advantages that can be achieved with the invention include the fact that a simple design change in the measuring segment avoids eddies and cross flows, consequently dispensing with the need for a compensation by means of additional sensors.

### BRIEF DESCRIPTION OF THE DRAWINGS

Embodiments of the invention are shown in schematic form in the drawings and will be described in greater detail below. The following are shown:

FIG. 1 the basic structure of a measuring device on the basis of a schematic diagram;

FIG. 2 a partial section through a measuring device; and

FIG. 3 the feed area leading to the measuring segment according to FIG. 2, as detail A.

### DETAILED DESCRIPTION

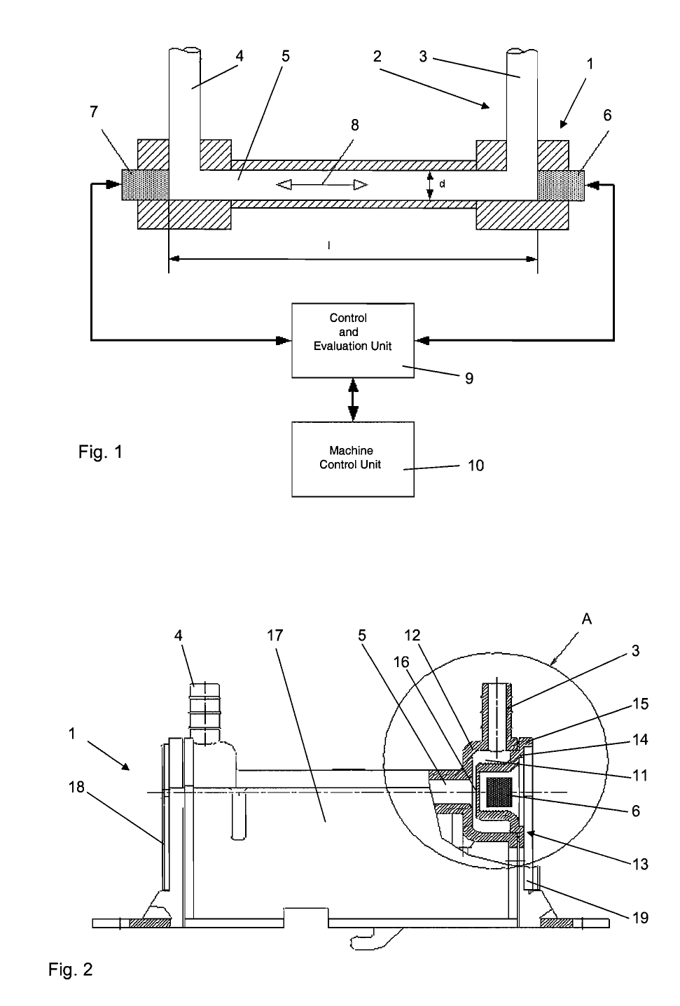

The measuring device 1 schematically depicted in FIG. 1 has a line section 2 through which the medium to be metered is conveyed. This section can be divided into an inlet 3, an outlet 4 and the measuring segment 5 located between them. The measuring segment 5 has a defined length 1 and a defined diameter d. The line section 2, as can be seen in the schematic diagram, is U-shaped, so that the interaction of ultrasound sensors 6 and 7 described below, which are located at the beginning and at the end of the measuring segment 5, makes it possible to determine what the medium itself is and/or its throughput volume.

The ultrasound signals (not presented in greater detail) are coupled into the measuring segment 5 on one side and received on the other side by the ultrasound sensor 6 or 7 positioned opposite, respectively. In this context, the two ultrasound sensors 6 and 7 function both as transmitters and receivers. As a result, the possibility exists to ascertain the type of medium or its flow rate in both directions of flow, which is indicated by the double-headed arrow 8. In order to determine the acoustic properties of the medium, a control and evaluation unit 9 is employed to carry out a running time measurement as well as an amplitude evaluation of both ultrasound signals. As the medium flows through the measuring segment, ultrasound signals are coupled simultaneously by both ultrasound sensors in order to measure the amount to be metered in. The control and evaluation unit determines the flow rate on the basis of the time shift with which the transmitted signals reach the appertaining receivers on the opposite side as a result of the medium flowing through the measuring segment. The phase angle resulting from the time shift, which is calculated by the control and evaluation unit 9, the diameter d and the length l of the measuring segment 5 are all utilized for purposes of ascertaining the volume flow of the medium.

The control and evaluation unit 9 interacts with a machine control unit 10 so that the metered amount can be introduced into the mechanical process as needed. For example, as a function of the volume flow, the machine control unit 10 can influence the duty cycle of a metering pump. Moreover, if the volume flow falls below a minimum value, it can be concluded that the medium container is empty or that a malfunction has occurred in the metering system, so that the current program is interrupted and/or an warning display is activated. This results in a self-regulating control mechanism for the amounts to be metered in, and from this, it can be assumed that an exact metering is being carried out by the metering system according to the invention.

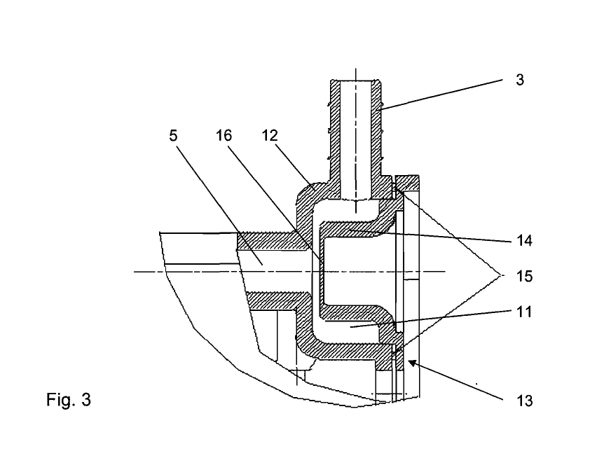

In order to avoid eddies and resulting cross flows when the medium is being fed into the measuring segment 5, which could falsify the measured results, a ring-shaped chamber 11 is arranged at each end, upstream and downstream from the measuring segment, as shown in FIGS. 2 and 3. This chamber 11 is configured as a circular or elliptical hollow cylinder or torus and it is positioned between the inlet 3 and outlet 4 and the actual measuring segment 5.

In the embodiment shown in FIGS. 2 and 3, a circular hollow cylinder is created in that a cap 13 having a likewise cylindrical indentation 14 is placed into a cylindrical widening 12 of the measuring segment and then butt-welded at the edge 15. The inlet 3 and the outlet 4 are then shaped as pipe connections on the cylindrical widenings 12 in such a way that they open into the outer circumferential surface area of the chamber 11. The bottom surface 16 of the indentation—which forms the place where the ultrasound is coupled into the measuring segment—is configured as a thin film, as a result of which it exhibits a low wave resistance. The ultrasound sensors 6 and 7 are placed as a single-piece component into the hollow spaces of the indentations 14, as schematically shown in FIG. 2.

The entire measuring device is accommodated in a housing 17 in whose bottom part a printed circuit board (not shown here) with the control and evaluation unit 9 can be housed. The transmitter-receiver components 6 and 7 are protected by closeable covers 18 and 19.

The scope of the present invention is not limited to the exemplary embodiments described herein; reference should be had to the appended claims.

What is claimed is:

1. A measuring device for measuring an amount of a rinsing additive to be metered into a rinsing, washing or disinfecting process in a rinsing machine, the measuring device comprising:
a measuring segment configured to convey the rinsing additive, the measuring segment having a defined length and a defined diameter, the measuring segment including a first cylindrical widening at an upstream end therof,
at least one ultrasound sensor associated with the measuring segment and configured to perform a measurement of at least one of a running time, an amplitude and a phase as a function of a flow rate of the rinsing additive so as to enable a determination of at least one of a type and an amount of the additive flowing through the measuring segment; and
a first cap including a first cylindrical indentation received in the cylindrical widening so as to form a first annular chamber.

2. The measuring device as recited in claim 1 wherein the annular chamber includes a form of at least one of a circular cylindrical annulus and an elliptical cylindrical annulus.

3. The measuring device as recited in claim 1 wherein the first cap is butt-welded to the first cylindrical widening at an edge thereof.

4. The measuring device as recited in claim 1 wherein the at least one ultrasound sensor includes a first ultrasound sensor disposed at the upstream end of the measuring segment and a second ultrasound sensor disposed at a downstream end of the measuring segment.

5. The measuring device as recited in claim 4 wherein the first and second ultrasound sensors each are respectively configured to function as both an ultrasound transmitter and an ultrasound receiver.

6. The measuring device as recited in claim 4 wherein the first ultrasound sensor is received in the first cylindrical indentation of the first cap, wherein the measuring segment includes a second cylindrical widening at a downstream end therof, and wherein a second cap including a second cylindrical indentation is received in the second cylindrical widening so as to form a second annular chamber, the second ultrasound sensor being received in the second cylindrical indentation.

7. The measuring device as recited in claim 6 wherein second annular chamber includes a form of at least one of a circular cylindrical annulus and an elliptical cylindrical annulus.

8. The measuring device as recited in claim 7 wherein the measuring segment is configured to connect to an inlet pipe at outer circumferential surface area of the first annular chamber and to an outlet pipe at an outer circumferential surface area of the second annular chamber.
